(19) United States
(12) Patent Application Publication
(10) Pub. No.: US 2019/0073629 A1
(43) Pub. Date: Mar. 7, 2019

(54) DRIVER MANAGEMENT SYSTEM

(71) Applicant: Flexport, Inc., San Francisco, CA (US)

(72) Inventor: Mary Elizabeth BECICA, El Cerrito, CA (US)

(21) Appl. No.: 16/121,396

(22) Filed: Sep. 4, 2018

Related U.S. Application Data
(60) Provisional application No. 62/555,593, filed on Sep. 7, 2017.

(51) Int. Cl. G06Q 10/08

(52) U.S. Cl. CPC G06Q 10/0833

(57) ABSTRACT

Disclosed herein are new systems for moving mass via trucks, drivers, dispatchers, and the trucking industry in general. In particular, this disclosure increases efficiency of moving mass from one location to another with end to end systems through consolidation of delivery requests and optimized assignments.

### TECHNICAL FIELD

This disclosure relates to the freight shipping industry. In particular, this disclosure relates to trucks, drivers, dispatchers, and trucking companies involved with moving mass from place to place.

### BACKGROUND

The freight shipping industry comprises many moving parts. Large amounts of mass are moved from one location to another via ships, planes, trains, etc., and requires attention to detail for successful deliveries. Despite the necessity for efficiency the current state of affairs is segmented and unnecessarily complicated.

Each step in delivering mass requires voluminous paperwork and coordination with different parties to ensure successful delivery. For example, when ships arrive at a port for delivery within a land mass, e.g., a continent, many truck drivers are needed to move mass to the final destination therein. Presently, there is no coordinated effort to efficiently manage all the delivery requests, drivers, trucks, and containers. The industry struggles in getting drivers to fulfill orders without experiencing surcharges for late deliveries or lost business. Surcharges add up quickly for fees related to late delivery, rental fees for space, custom and international fees, etc.

The development and integration of Global Positioning Systems (GPS) offers some opportunities for improving efficiency within the trucking industry. A GPS device allows satellites to relay information regarding the location of a person or thing. As well as the movement of said person or thing allowing users to track their movement. GPS also makes it possible for a driver to receive directions without manually reading maps, which can cause distractions and potential accidents on the road. GPS also allows dispatchers to track the movement of drivers and analyze the progress of a delivery and relay that information to customers.

Despite the use of GPS, the trucking industry is still plagued with efficiency problems. To date, the industry has only developed point solutions. Most of the technology in the trucking industry focuses on providing assistance to only one party of the larger network of parties working together to deliver mass.

A traditional work flow involves sending a delivery order to a dispatch office, where the dispatch office takes in the volume, organizes the delivery orders, and schedules the work internally. Then, a driver makes a delivery, certifies the delivery, reports any noteworthy issues, e.g., damages to shipments, and makes a separate invoice. The problem exists in that there are two separate parties working together to fulfill the delivery, but the information is segmented with no efficient and reliable way to communicate. Also, there is redundancy in this system which creates unneeded duplicate work, confusion, and efficiency loss.

There exists a need for end to end solutions for delivering mass via trucks. There also exists a need for managing drivers to effectively and efficiently deliver mass. In particular, there exists a need for tracking and logging the movement of a driver. There exists a need for managing the movement of mass by drivers, including ensuring the driver complies with rules and regulations.

### BRIEF DESCRIPTION OF THE DRAWINGS

FIG. 1 illustrates one example of Driver 101 driving Truck 102 with Mass 103 from Port of Discharge 104 to Destination 105, Destination 106, and Destination 107 on Road 108.

FIG. 2 illustrates one example of Mass 204 at Port 201 within Geofence 205 with Vessel 202 and Vessel 203 moving in and out of Port 201 and Geofence 205 heading towards Destination 206, 207, and 208.

FIG. 3 illustrates one example of a flow chart of the Work Distributor assessing Deliveries, e.g., by collecting delivery request, and assigning Deliveries to Drivers.

### DETAILED DESCRIPTION

Disclosed herein is a new end to end system for delivering mass via trucks. In one embodiment, the systems disclosed herein track the movement of mass, e.g., an object such as a Physical Concrete and Tangible Object. In one embodiment, the systems disclosed herein track the movement of a Driver. In one embodiment, the systems disclosed herein track the movement of a Truck. In one embodiment, the systems disclosed herein certify or confirm a Delivery, e.g. arrival, at a distribution center.

Disclosed herein is new system for managing Drivers for effectively and efficiently delivering mass. In one embodiment, the systems disclosed herein distribute Deliveries to Drivers. In one embodiment, the systems disclosed herein prompt a Driver to produce an invoice for completing a Delivery, e.g., physical tangible display means, e.g., a message on a screen.

In one embodiment, the systems disclosed herein ensure compliance of laws and regulations for delivering mass, e.g., a Driver not exceeding maximum Hours of Service. In one embodiment, the systems disclosed herein track the Hours of Service and reminds the Driver of number of hours, e.g., a message on a screen. For example, in one embodiment, the systems disclosed herein track and log the position and time of an Object, e.g., a Driver, a Truck, a Container, etc., with a Clock. In one embodiment, the systems disclosed herein provide a physical tangible display means, e.g., a screen. In one embodiment, the systems disclosed herein log compliance events. In one embodiment, the systems disclosed herein log hours driving. In one embodiment, the systems disclosed herein remind the Driver of laws and regulations, e.g., the systems disclosed herein sends a message appearing on a screen. In one embodiment, the systems disclosed herein provide a Driver with real-time information relevant to laws, e.g., hours worked and hours remaining to work during a particular period. For example, a meter on a physical tangible display means, e.g., a scale from 0 to 100%.

Disclosed herein is a Driver Management System, comprising:
a First Client;
a First Delivery Order;
a First Physical Concrete and Tangible Object;
a First Container;
a Truck;
a Driver;
a First Destination;
a Second Destination;
a means for tracking a position of an Object; and
a Clock.

As used herein, the term “Client”, e.g., a First Client, a Second Client, a Third Client, etc., refers to an entity controlling mass, e.g., a person or business possessing an object needing to move from one position to another. In one embodiment, the Client is a human being. In one embodiment, the Client is a business. In one embodiment, the Client owns the mass. In one embodiment, the Client manages the mass. In one embodiment, the Client manages and/or cares for the mass. In one embodiment, the Client creates the mass. In one embodiment, the Client possesses physical control of the mass. In one embodiment, the Client needs to move mass. In one embodiment, the Client engages with a Freight Forwarder to move mass. In one embodiment, there is a First Client. In one embodiment, there is a Second Client. In one embodiment, there is a Third Client. In one embodiment, the First Client sends mass to the Second Client. In one embodiment, the First Client sends mass to the Second Client and the Second Client sends mass to the Third Client. In one embodiment, there are more than three Clients. In one embodiment, the Client transfers control of the mass to a Consignee, e.g., by transferring mass to a Freight Forwarder, selling mass to another person, and/or shipping mass to another entity, etc.

As used herein, the term “Delivery Order” refers to a request for moving mass from one location to another. In one embodiment, the Client submits a Delivery Order to a Freight Forwarder, e.g., a phone call, email, text message, mail, or any other communication means. In one embodiment, the Freight Forwarder uses the systems disclosed herein to send the Delivery Order to a Dispatcher. In one embodiment, the Dispatcher assigns the Delivery Order to a Driver. In one embodiment, a Driver fulfills the Delivery Order. In one embodiment, the Delivery Order comprises a mass moving from a Port of Discharge to a warehouse. In one embodiment, the Delivery Order comprises mass moving from a Port of Discharge to a distribution center. In one embodiment, the Delivery Order comprises a mass moving from a first warehouse to a second warehouse. In one embodiment, the Delivery Order comprises a mass moving from a warehouse to a port. In one embodiment, the Delivery Order comprises a Driver confirming receipt of a mass, e.g., a Physical Concrete and Tangible Object. For example, the systems disclosed herein generate a form on a screen for the Driver to fill.

As used herein, the term “Physical Concrete and Tangible Object” refers to an object made of matter, having mass, and occupying space. In one embodiment, the Physical Concrete and Tangible Object is a product. In one embodiment, the Physical Concrete and Tangible Object is a collection or plurality of objects. In one embodiment, the plurality of objects are packaged into a consolidated object, e.g., a collection of cellular phones into a box. In one embodiment, the Physical Concrete and Tangible Object is a quantity, mass, weight, and/or volume of products requiring utilization of a full container load (FCL). In one embodiment, the Physical Concrete and Tangible Object is a quantity, mass, weight, and/or volume of products requiring utilization of a less than container load (LCL), e.g., a pallet. In one embodiment, the Physical Concrete and Tangible Object is a pallet of products, e.g., a pallet of clothing, a pallet of electronic devices, a pallet of hazardous materials, etc., which may (or may not) be further segmented and packaged, e.g., placed into boxes.

As used herein, the term “mass” refers to matter occupying space and making up or forming an object. In one embodiment, mass is expressed in metric units, e.g., grams, kilograms, etc. In one embodiment, mass is expressed in pounds. In one embodiment, there is a First mass. In one embodiment, there is a Second mass. In one embodiment, there is a Third mass. In one embodiment, there are more than three masses. In one embodiment, the mass is a shirt. In one embodiment, the mass is a shirt on a pallet. In one embodiment, the mass is a shirt in a box.

As used herein, the term “Freight Forwarder” refers to an entity possessing temporary control of a mass. In one embodiment, the Freight Forwarder comprises temporary control of a mass belonging to or under the care/control of a Client. In one embodiment, the Freight Forwarder engages in a contractual relationship with a Client to possess the mass. In one embodiment, the contractual relationship is a Delivery Order. In one embodiment, the Freight Forwarder warrants possession of mass. In one embodiment, the Freight Forwarder transfers control of mass to a Driver. In one embodiment, the Driver acts on behalf of a Freight Forwarder to move mass.

As used herein, the term “Container” refers to an enclosure capable of containing mass. In one embodiment, the Container is open. In one embodiment, the Container is closed. In one embodiment, the Container comprises freight, e.g., a rectangular prism. In one embodiment, the Container is placed onto (or attached to) a Truck. In one embodiment, the Container contains a pallet (or multiple pallets) of mass, e.g., clothing, electronic devices, etc. In one embodiment, the Container contains mass from a First Client. In one embodiment, the Container contains mass from more than one Client, e.g., a First Client and a Second Client or a First Client, Second Client, and Third Client.

As used herein, the term “Twenty-Foot-Equivalent Unit”, or “TEU”, refers to a unit of capacity of a container, i.e., a 20′ container. Within the context of this disclosure, TEU may be expressed in volume, mass, or other useful means for quantifying Physical Concrete and Tangible Objects.

As used herein, the term “Forty-Foot-Equivalent Unit”, or “FEU”, refers to a unit of capacity of a container, i.e., a 40′ container. In one embodiment, the FEU is two 20′ containers. In one embodiment, the FEU is a 40′ container. In one embodiment, the FEU is a 40 High Cube container. Within the context of this disclosure, FEU may be expressed in volume, mass, or other useful means for quantifying Physical Concrete and Tangible Objects.

As used herein, the term “Truck” refers to a vehicle designed for moving mass, e.g., equipped for pulling an attached container of mass. In one embodiment the Truck is equipped to pull or haul a 20-foot container. In one embodiment the Truck is equipped to pull or haul a 40-foot container. In one embodiment, the Truck comprises a diesel engine. In one embodiment, the Truck comprises a chassis. In one embodiment, the Truck comprises a cab. In one embodiment, the Truck comprises an area for placing cargo or equipment. In one embodiment, the Truck comprises an axle. In one embodiment, the Truck comprises a suspension. In one embodiment, the Truck comprises a road wheel. In one embodiment, the Truck comprises an engine. In one embodiment, the Truck comprises a drivetrain. In one embodiment, the Truck comprises a GPS device or other means for determining and transmitting the position (e.g., the real-time position) of the Truck. In one embodiment, the Truck comprises an autologging device (aka an “autologger”). In one embodiment the Truck comprises an activity monitor, which captures, records, logs, and/or transmits the status of the Truck, containers attached to the truck, objects inside the containers, and/or parts or aspects thereof.

As used herein, the term “Driver” refers to an entity controlling a vehicle, such as a truck, for example a person driving a truck for purposes of moving mass from one location to another. In one embodiment, the Driver is a user of the systems disclosed herein. In one embodiment, the Driver confirms receipt of mass from a Port of Discharge, e.g., by inputting data with the systems disclosed herein, e.g., via mobile device. In one embodiment, the Driver delivers the mass to a Destination. In one embodiment, the Driver moves the mass from a Port of Discharge to a Destination. In one embodiment, the Driver operates a Truck. In one embodiment, the Truck comprises mass, e.g., in an attached container filled with one or more objects, and the Driver delivers the mass from one location to another, e.g., a Port of Discharge to a warehouse. In one embodiment, the Driver moves a Physical Concrete and Tangible Object from Los Angeles to Long Beach. In one embodiment, the Driver moves a Physical Concrete and Tangible Object from New York to Seattle. In one embodiment, the Driver moves a Physical Concrete and Tangible Object from San Francisco to Chicago. In one embodiment, the Driver's activity is restricted by rules and/or regulations, e.g., only driving a limited amount of hours within a particular time period, e.g., 30 hours in a certain time window. In one embodiment, the Driver comprises a GPS device or other means for determining and transmitting the real-time position of the Driver.

As used herein, the term “Destination” refers to a physical, geographical location to which an object is moved or sought to be moved. In one embodiment, the Destination is a location for which mass is intended to remain stationary after movement. In one embodiment, the Destination is one point within a series of Destination points, which may be described as First, Second, Third, etc., Destination. In one embodiment, the movement of mass comprises a First Destination. In one embodiment, the movement of mass comprises a Second Destination. In one embodiment, the movement of mass comprises a Third Destination. In one embodiment, the movement of mass comprises delivering mass to a First Destination and then to a Second Destination. In one embodiment, the movement of mass comprises delivering mass to a First Destination, to a Second Destination, and then to a Third Destination. In one embodiment, the movement of mass comprises more than three Destinations. In one embodiment, the Destination is a Port of Discharge (POD). In one embodiment, the Destination is a warehouse, e.g., Amazon warehouse, distribution center, Freight Forwarder's distribution center or warehouse, or retailer warehouse. In one embodiment, the Destination is a retail store. In one embodiment, the Destination is a wholesale store. In one embodiment, the Destination is a Port of Loading. In one embodiment, the Destination is Seattle. In one embodiment, the Destination is New York. In one embodiment, the Destination is San Francisco. In one embodiment, the mass travels from a First Destination to a Second Destination, e.g., Long Beach to New York.

In one embodiment, the Destination is determined by a delivery order. In one embodiment, the Destination is described by an address. In one embodiment, the Destination is described by latitude and longitude coordinates. In one embodiment, information about the location of the Destination and/or Origin is presented on a display means, along with a map, showing and illustrating, for example, the present driver location, present truck location, Origin location, and/or Destination location. In one embodiment, one or more of these locations is determined by a GPS device or other means for tracking.

As used herein, the term “Port of Discharge” aka “POD” refers to a location from which mass is removed from a Carrier's authority, e.g., by transferring physical and/or constructive possession to a Freight Forwarder, a First Client, etc. In one embodiment, the Port of Discharge is the same location as the First Destination. In one embodiment, the Port of Discharge is the location where mass is removed from a container. In one embodiment, the systems disclosed herein automatically prompt a Dispatcher of mass arriving at a Port of Discharge. In one embodiment, the Port of Discharge is the location where a Consignee relinquishes control of mass, e.g., by signing a discharge paper with the systems disclosed herein. In one embodiment, the Port of Discharge is the location where mass is placed into/onto a Truck. In one embodiment, the Port of Discharge is where mass is placed into a container. In one embodiment, the Port of Discharge is Long Beach. In one embodiment, the Port of Discharge is New York. In one embodiment, the Port of Discharge is Oakland. In one embodiment, the Port of Discharge is where a Client sends mass. In one embodiment, the Port of Discharge is where a Consignee is located.

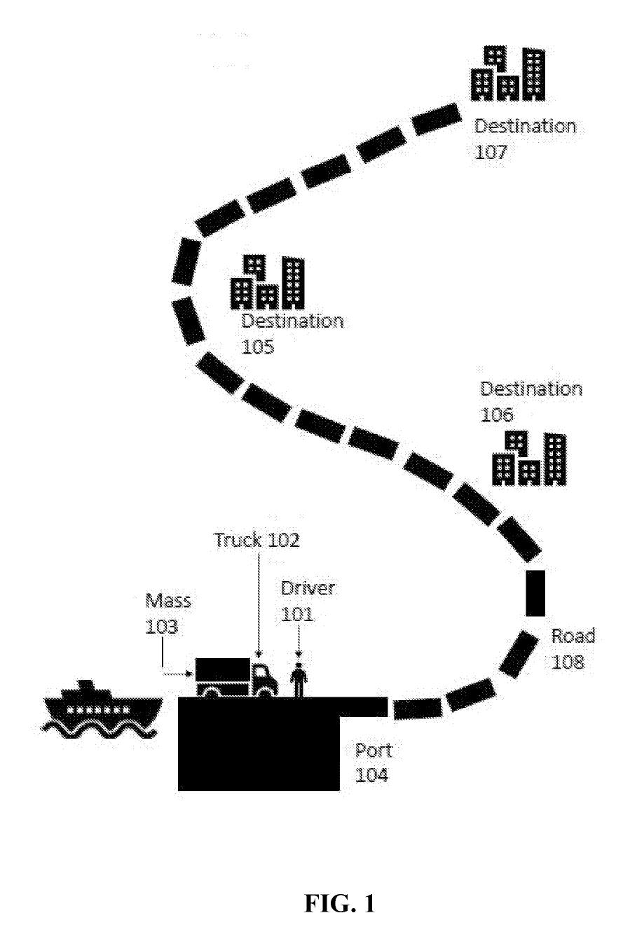

FIG. 1 is an illustrative example of how Driver 101 drives Truck 102 to move Mass 103 from Port 104 to Destinations 105, 106, and 107 along road 108. In one embodiment, the systems disclosed herein automatically log information at a Port of Discharge, e.g., mass leaving a Port of Discharge, mass transferred into a Container, etc.

In one embodiment, the Physical Concrete and Tangible Object is divided into portions. In one embodiment, each portion is sent to one or more locations, which may be the same or different. In one embodiment, the Port of Discharge is a port. In one embodiment, the Port of Discharge is an airplane hanger. In one embodiment, the Port of Discharge is a train station. In one embodiment, the Port of Discharge is a distribution center.

As used herein, the term “means for tracking” refers to the ability to follow and determine the position and/or movement of an Object, e.g., by using a GPS device or any other means for determining or tracking position. In one embodiment, the means for tracking comprises a Global Positioning System (GPS) device, e.g., a GPS affixed on a Truck. In one embodiment, the means for tracking comprises a GPS device affixed to a Driver. In one embodiment, the means for tracking comprises a GPS device positioned in or on a Container. In one embodiment, the means for tracking comprises a GPS device positioned on a pallet. In one embodiment, the means for tracking comprises a GPS device positioned on a package, parcel, or box. In one embodiment, the means for tracking comprises a GPS device positioned on an individual item. In one embodiment, the means for tracking comprises following the position of an Object as said object moves, e.g., along a path, e.g., a road. In one embodiment, the means for tracking comprises utilizing a map. In one embodiment, the means for tracking comprises using coordinates, e.g., longitude and latitude, addresses, etc. In one embodiment, the systems disclosed herein automatically log and record the path and time of an Object. In one embodiment, the systems disclosed herein prompt the Driver to input or confirm the path and time. In one embodiment, the means for tracking comprises following the Object's position in real time.

Within the context of this disclosure, the term “real time” is understood to not mean the exact time an event occurs. For example, a delay in time occurring when a GPS device transmits the position of an Object in real time. In one embodiment, real time comprises frequent updates of transmission, e.g., a Clock relating the time to the position of an Object.

As used herein, the term “position” refers to a physical geographical location of an Object, either stationary or moving. In one embodiment, the position comprises longitudinal and/or latitudinal coordinates, e.g., GPS coordinates. In one embodiment, the position comprises the location of a Truck, e.g., at a port or on a highway. In one embodiment, the position comprises the location of a Physical Concrete and Tangible Object in a city, e.g., at an address, e.g., a street, building, etc. In one embodiment, the position is determined by GPS coordinates. In one embodiment, the position is determined by a map. In one embodiment, the position is determined by landmarks. In one embodiment, the position is determined by an address. In one embodiment, the position is determined or defined within a Geofence.

As used herein, the term “Object” refers to a physical item made of matter and having mass, e.g., the thing in which the systems disclosed herein track. In one embodiment, the Object is the Truck. In one embodiment, the Object is a Physical Concrete and Tangible Object. In one embodiment, the Object is a Container. In one embodiment, the Object is a Driver, e.g., the Driver of a Truck where said Truck is pulling a container comprising mass to be delivered to a Destination. In one embodiment, the Object comprises a means for tracking, e.g., a GPS device on a Truck. In one embodiment, the Object is the value of interest, e.g., the Physical Concrete and Tangible Object meant to be delivered.

As used herein, the term “Clock” refers to an instrument for measuring time. In one embodiment, the Clock is an analog clock. In one embodiment, the Clock is a digital clock. In one embodiment, the systems disclosed herein use the Clock for measuring the amount of time a Driver is on the road. In one embodiment, the Clock measures the time for delivering a mass from a Port of Discharge to a First Destination. In one embodiment, the Clock measures the time for delivering a mass from a Port of Discharge to a Second Destination. In one embodiment, the Clock measures the time for delivering a mass from a First Destination to a Second Destination. In one embodiment, the Clock provides the current time. In one embodiment, the Clock provides time based on time zones. For example, the Clock will change time when a Truck moves from the Eastern Time Zone to the Pacific Time Zone. In one embodiment, the Clock measures elapsed time. For example, the elapsed time from when a mass leaves a Port of Discharge to when it arrives at a First Destination. In one embodiment, the Clock measures elapsed time automatically. In one embodiment, the Clock measures elapsed time within a Geofence. In one embodiment, the Clock measures time within a port. In one embodiment, the Clock measures time within a yard. In one embodiment, the Clock measures time a Driver is in possession of mass. In one embodiment, the Clock measures the time a mass is within a Container. In one embodiment, the Clock measures the time a mass is in a Truck. In one embodiment, the systems disclosed herein automatically records the time using the Clock. In one embodiment, the systems disclosed herein prompt the Driver to log information from the Clock. In one embodiment, the Driver controls the Clock.

In one embodiment, the systems disclosed herein comprise a means for measuring Displacement of an Object.

As used herein, the term “means for measuring Displacement” refers to the ability to determine the difference in position, e.g., by distance, e.g., miles, feet, meters, kilometers, etc., between an initial position and a second point of reference. In one embodiment, the Displacement is the distance between a First Destination and a Second Destination. In one embodiment, the Displacement is the distance between a Port of Discharge and a First Destination. In one embodiment, the means for measuring Displacement comprises placing a GPS device onto a Truck. In one embodiment, the means for measuring Displacement comprises velocity, e.g., the change in position of an Object as a function of time. For example, determining the velocity of a Physical Concrete and Tangible Object as said Physical Concrete and Tangible Object leaves a Port of Discharge.

In one embodiment, the systems disclosed herein comprise a Geofence.

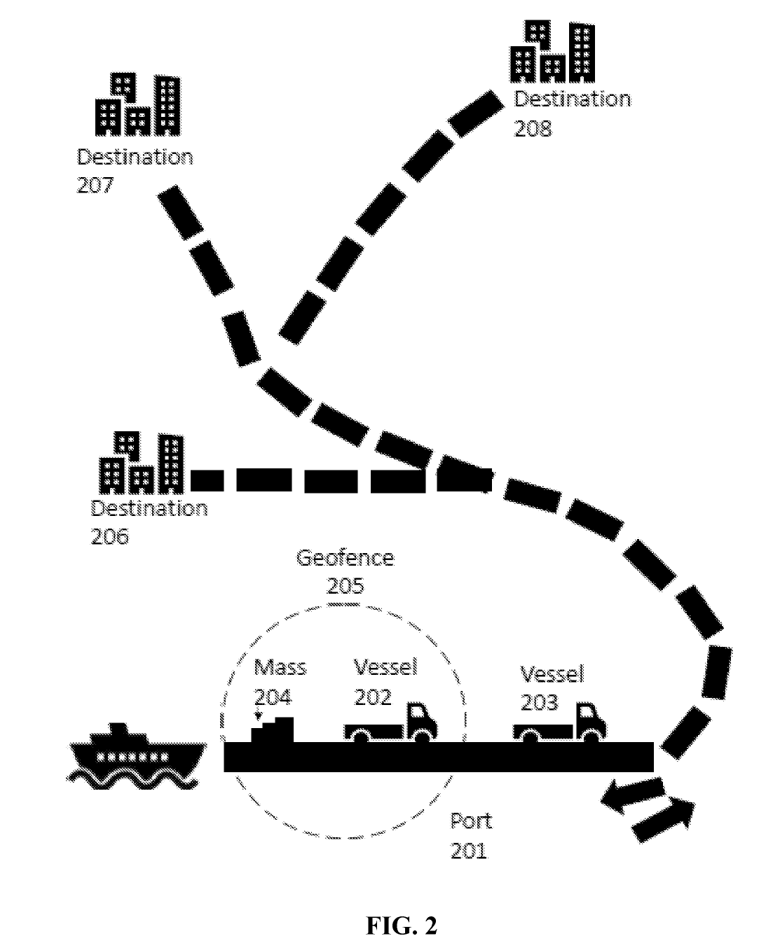

As used herein, the term “Geofence” refers to a perimeter, which may be either physical or not physical, e.g., defined by spatial coordinates, e.g., latitude and longitude, e.g., with GPS. In one embodiment, the Geofence encompasses a Port of Discharge. In one embodiment, the Geofence encompasses a Port of Loading. In one embodiment, the Geofence encompasses a yard. In one embodiment, the Geofence encompasses a warehouse. In one embodiment, the Geofence encompasses a distribution center. In one embodiment, the Geofence encompasses a Destination, e.g., the final location of a Delivery Order. In one embodiment, the systems disclosed herein track the position of an Object, e.g., a Driver, a Truck, etc., within a Geofence. In one embodiment, an Object leaves or enters a Geofence. In one embodiment, the systems disclosed herein track and log when an Object enters or leaves a Geofence, e.g., recording the time a Truck leaves a Geofence. In one embodiment, the Geofence is generated virtually, e.g., a GPS creates a perimeter. In one embodiment, the Geofence surrounds a mass. In one embodiment, the Geofence moves with the mass, e.g., a Geofence travels with a Truck carrying mass. In one embodiment, the Geofence comprises coordinates, e.g., longitude and latitude. FIG. 2 illustrates one example of Mass 204 at Port 201 within Geofence 205 with Vessel 202 and Vessel 203 moving in and out of Port 201 and Geofence 205 heading towards Destination 206, 207, and 208.

In one embodiment, the systems disclosed herein comprise an Activity Monitor.

As used herein, the term “Activity Monitor” refers to an instrument measuring an Object's displacement as a function of time, for example whether an Object is moving, at what rate, in what directions, etc., for a chosen window of time. In one embodiment, the Activity Monitor comprises a GPS measuring the movement of a mass. In one embodiment, the Activity Monitor measures the Displacement of a Truck. In one embodiment, the Activity Monitor measures the Displacement of a Driver. In one embodiment, the Activity Monitor measures the Displacement of a Physical Concrete and Tangible Object. In one embodiment, the Activity Monitor measures the Displacement in meters. In one embodiment, the Activity Monitor measures the Displacement in kilometers. In one embodiment, the Activity Monitor measures the Displacement in miles. In one embodiment, the Activity Monitor determines when the Driver is active by measuring displacement, e.g., when the Driver is moving. In one embodiment, the Activity Monitor determines when the Driver is inactive, e.g., when the Driver is not moving. In one embodiment, the systems disclosed herein use activity to record/log the total active time of a Driver. In one embodiment, the systems disclosed herein compares the activity of a Driver with laws and regulations, e.g., exceeding allotted time for activity, changes with a law or regulation, etc. In one embodiment, the Activity Monitor provides alerts to a Driver. In one embodiment, the Activity Monitor assists in allocating remaining time for the duration of a Delivery. In one embodiment, the Activity Monitor measures the time of activity, e.g., elapsed time for a particular type of activity, such as very slow velocity or cruising speeds, etc. In one embodiment, the Activity Monitor equates elapsed time to certain activity, e.g., moving at high velocities equates to moving mass. In one embodiment, the Activity Monitor begins measuring time when a key is in the ignition of a Truck. In one embodiment, the Activity Monitor measures time when a Truck is moving. In one embodiment, the Activity Monitor measures time when a Driver is in/around a Truck, e.g., via a GPS device or any other means for tracking position.

In one embodiment, the systems disclosed herein comprise an Autologger.

As used herein, the term “Autologger” refers to an instrument for monitoring and recording the activity of a Driver. In one embodiment, the Driver utilizes the Autologger to track activity. In one embodiment, the Autologger comprises a graphical user interface. In one embodiment, the Autologger determines and records the activity of the Driver. In one embodiment, a Driver is moving and the Autologger determines whether the Driver is moving along the prescribed path. In one embodiment, the auto-logger records elapsed time. In one embodiment, the Autologger determines whether the Driver's location is relevant to the Delivery. In one embodiment, the Autologger determines when a Driver stops at a gas station the Driver is active. In one embodiment, the Autologger determines whether the Driver is off duty. In one embodiment, the Autologger determines whether the Driver is inactive. In one embodiment, the Autologger determines whether the Driver is on duty. In one embodiment, the Autologger determines and records whether the Driver is active. In one embodiment, when a Driver arrives at a Delivery location the Driver logs or inputs confirmation of receipt by a Consignee, e.g., by having the Consignee sign a form, marking a sheet, or using a graphical user interface. In one embodiment, when the Driver arrives at a Delivery location the Driver enters confirmation of no damage, e.g., by making a comment on a graphical user interface. In one embodiment, the Driver confirms a Physical Concrete and Tangible Object has left a Port of Discharge, e.g., the systems disclosed herein prompt a message to which the Driver responds, e.g., pushing a button. In one embodiment, the Driver confirms that multiple Physical Concrete and Tangible Objects have left a Port of Discharge, e.g., the systems disclosed herein prompt a message to which the Driver responds, e.g., pushing a button. In one embodiment, the Autologger logs information on a Cloud database.

In one embodiment, the Autologger comprises a physical, tangible display means.

As used herein, the term “physical, tangible display means” refers to a visual medium for presenting information in a concrete form. In one embodiment, the physical, tangible display means comprises a graphical user interface, such as a mobile device with a touchscreen. In one embodiment, the physical, tangible display means comprises a screen, such as a mobile device. In one embodiment, the physical, tangible display means comprises a computer. In one embodiment, the physical, tangible display means comprises a mobile device. In one embodiment, the physical, tangible display means comprises paper, e.g., a facsimile or print out. In one embodiment, the physical, tangible display means comprises a touch screen. In one embodiment, the physical, tangible display means comprises a graphical representation of a map. In one embodiment, the physical, tangible display means comprises a graphical representation of a Clock. In one embodiment, the physical, tangible display means comprises a list of Deliveries. In one embodiment, the physical, tangible display means comprises symbols for distinguishing particular events, entities, things, or locations, e.g., completing a Delivery, a Destination point, etc.

In one embodiment of the systems disclosed herein, the Autologger measures Hours of Service.

As used herein, the term “Hours of Service” refers to the amount of time a Driver is active on the job. In one embodiment, the Hours of Service comprises time spent driving a Truck. In one embodiment, the Hours of Service comprises time spent moving mass from one location to another. In one embodiment, the Hours of Service are measured or analyzed within a time period, e.g., per day, per week, per month, etc. In one embodiment, the Hours of Service are represented in hours. In one embodiment, the Hours of Service are represented in minutes. In one embodiment, the Hours of Service are represented in seconds. In one embodiment, the Hours of Service are represented in days. In one embodiment, the Hours of Service are represented in weeks. In one embodiment, a Driver is not allowed to exceed the allotted Hours of Service. In one embodiment, the Activity Monitor measures and records a Driver's Hours of Service.

In one embodiment of the systems disclosed herein, the Autologger determines and/or documents the nature of the activity of an object, e.g., whether a Driver is on duty or off duty.

As used herein, the terms “on duty” and “off duty” refer to when a Driver is working on the job, e.g., by participating in activities for completing a Delivery. A Driver's ability to move mass may be limited or defined by conditions, laws, contract, regulations, etc. In one example, the Driver can only drive a certain number of hours within a 24-hour time period. In one example, the Driver is required to have a certain ratio of non-activity to activity. In one embodiment, the Driver is on duty when driving a Truck from a Port of Discharge to a First Destination. In one embodiment, the Driver is off duty when the truck is stationary with the engine turned off. In one embodiment, the Driver is on duty when evaluating the order of deliveries, e.g., interacting with the methods and systems disclosed herein, e.g., by interacting with the GUI or display means. In one embodiment, the Driver is off duty when not driving. In one embodiment, the time a Driver is on duty contributes to Hours of Service. In one embodiment, the time a Driver is off duty does not contribute to Hours of Service.

In one embodiment of the systems disclosed herein, the Autologger documents completion of a Delivery.

As used herein, the term “Delivery” refers to the movement of mass to an intended recipient or location, from one location to another. In one embodiment, the Client receives a request for Delivery of mass. In one embodiment, the Client engages with a Freight Forwarder to achieve Delivery of a mass. In one embodiment, the Freight Forwarder engages with a Driver to achieve Delivery of a mass. In one embodiment, the Delivery is the receipt of mass by a Consignee. In one embodiment, the Delivery is the movement of mass from a Port of Discharge to a First Destination. In one embodiment, the Freight Forwarder engages with a Carrier to move mass. In one embodiment, the Delivery is from San Francisco to Phoenix. In one embodiment, the Delivery is from Los Angeles to Las Vegas.

As used herein, the term “documents completion of a Delivery” refers to creating a record of a Delivery. In one embodiment, the Consignee of a Delivery signs a document. In one embodiment, the Driver verifies a Delivery utilizing the systems disclosed herein, e.g., the GUI prompts the Driver for completion of a Delivery. In one embodiment, the Driver is prompted to create a document for completion of a Delivery. For example, a Driver is prompted to create a document for completion of a Delivery when an Object reaches a Destination. In another example, the Driver is prompted to document completion of a Delivery when an Object leaves a Geofence. In another example, a Driver is prompted to document completion of a Delivery when the Driver leaves a Destination. In one embodiment, the Driver creates an invoice for payment of Delivery utilizing the systems disclosed herein.

As used herein, the term “invoice” refers to a record an exchange of services and/or products. In one embodiment, the invoice comprises information relating to a Delivery of mass. In one embodiment, the systems disclosed herein automatically generate an invoice for a Delivery. In one embodiment, the invoice is for a Delivery between a Client and Carrier. In one embodiment, the systems and methods disclosed herein comprise multiple steps within a payment flow process. For example, the systems and methods disclosed herein comprise capturing charges, e.g., by identifying activity and correlating that activity with a particular fee structure. In another example, the systems and methods disclosed herein comprise generating a particular change on an invoice, e.g., by identifying activity and correlating that activity with a particular fee structure, then automatically creating a line item for a particular change on an invoice. In one embodiment, the systems and methods disclosed herein comprise sending an invoice. In one embodiment, the systems and methods disclosed herein comprise receiving of payment of the invoice. In one embodiment, the systems and methods disclosed herein comprise identifying activity and correlating that activity with a particular fee structure, then automatically creating a line item for a particular change on an invoice, and automatically sending the invoice to a party. In one embodiment, the systems and methods disclosed herein comprise identifying activity and correlating that activity with a particular fee structure, then automatically creating a line item for a particular change on an invoice and automatically sending the invoice to a party, then receiving payment for the invoice. In one embodiment, the above described multiple steps within a payment flow process are presented on a tangible display means.

In one embodiment, the systems disclosed herein comprise a Reminder.

As used herein, the term “Reminder” refers to a message providing timely information, e.g., a text message on a graphical user interface. In one embodiment, the Reminder comprises a text message. In one embodiment, the Reminder comprises an email. In one embodiment, the Reminder comprises a visual medium, e.g., a graphical user interface. In one embodiment, the Reminder comprises a color-based system, e.g., a series of colors. In one embodiment, the Reminder comprises a notice of a pending Delivery. In one embodiment, the Reminder comprises sounds, e.g., beeps. In one embodiment, the Reminder comprises a timeline. In one embodiment, the Reminder occurs repeatedly until completion of said action, e.g., completion of a Delivery. In one embodiment, the Reminder comprises a time remaining to complete an action.

In one embodiment, the systems disclosed herein comprise a Dispatcher.

As used herein, the term “Dispatcher” refers to an entity distributing Deliveries for completion. In one embodiment, the Dispatcher is a user of the systems disclosed herein. In one embodiment, the Dispatcher is a Driver. In one embodiment, the Dispatcher receives requests for a Delivery from a Freight Forwarder. In one embodiment, the Dispatcher receives a request for a Delivery from a Client. In one embodiment, the Dispatcher receives a request for a Delivery from a second Dispatcher. In one embodiment, the Dispatcher receives a request for a Delivery from a Driver. In one embodiment, the Dispatcher coordinates the movement of multiple Physical Concrete and Tangible Objects from a Port of Discharge to different Destinations. In one embodiment, the Dispatcher uses the systems disclosed herein to track the progress of Deliveries from a Driver. In one embodiment, the Dispatcher uses the systems disclosed herein to track the progress of Deliveries from two or more Drivers.

In one embodiment, the systems and methods describe herein provide for driver and vehicle fleet management beyond the context of making deliveries and dispatching work to drivers. For example, within a conventional trucking company, the systems and methods described herein monitor the compliance of vehicles and drivers. For example, aside from assigning and monitoring work (e.g., delivery orders), the systems and methods disclosed herein monitor information relevant to insurance validity, license validity, legal identifiers, etc. This information, along with information regarding assigning and monitoring work, fulfills a longstanding need for tracking and managing an entire fleet—including compliance and/or fulfillment.

In one embodiment of the systems disclosed herein, the Reminder prompts the Dispatcher for input based on the position of an Object. In one embodiment, the Dispatcher utilizes the systems disclosed herein to log input, e.g., through a physical, tangible display means. In one embodiment, the physical, tangible display means disclosed herein comprise a GUI, e.g., a touch screen or computer equipped with a monitor. In one embodiment, the physical, tangible display means disclosed herein comprise a keyboard. In one embodiment, the physical, tangible display means disclosed herein additionally comprises voice recognition.

As used herein, the term “prompts the Dispatcher for input based on the position of an Object” refers to requesting information from a Dispatcher relating to an Object. In one embodiment, the Dispatcher is prompted to input the physical location of the Object, e.g., location of the Truck, Driver, Physical Concrete and Tangible Object, etc. For example, when an Object leaves the perimeter of a Geofence. In one embodiment, the Dispatcher determines whether the Driver is on duty or off duty. In one embodiment, the Dispatcher is prompted to input Hours of Service. In one embodiment, the Dispatcher is prompted to input the estimated or desired arrival time of the Delivery. In one embodiment, the Dispatcher is prompted to input a new estimated or desired time of arrival.

In one embodiment of the systems disclosed herein, the Reminder prompts the Dispatcher for input based on output from the Activity Monitor. In one embodiment, the systems disclosed herein automatically input information. For example, when a Driver places mass onto a Truck, the systems disclosed herein automatically recognize that the mass has been picked up. In a further example, the systems disclosed herein automatically generate an estimated or desired time of arrival.

As used herein, the term “prompts the Dispatcher for input based on output from the Activity Monitor” refers to requesting information from the Dispatcher based on the information attained by the Activity Monitor. For example, where the Dispatcher determines from the Activity Monitor that a Delivery is moving slower than expected, the Dispatcher marks the Delivery as delayed. In one embodiment, the Dispatcher determines that the Driver has exceeded the Hours of Service and halts the Drivers activity and/or the Delivery and/or reassigns the Delivery. In one embodiment, the systems disclosed herein automatically prompts the Dispatcher for input based on output from the Activity Monitor.

In one embodiment, the systems disclosed herein comprise a Work Distributor.

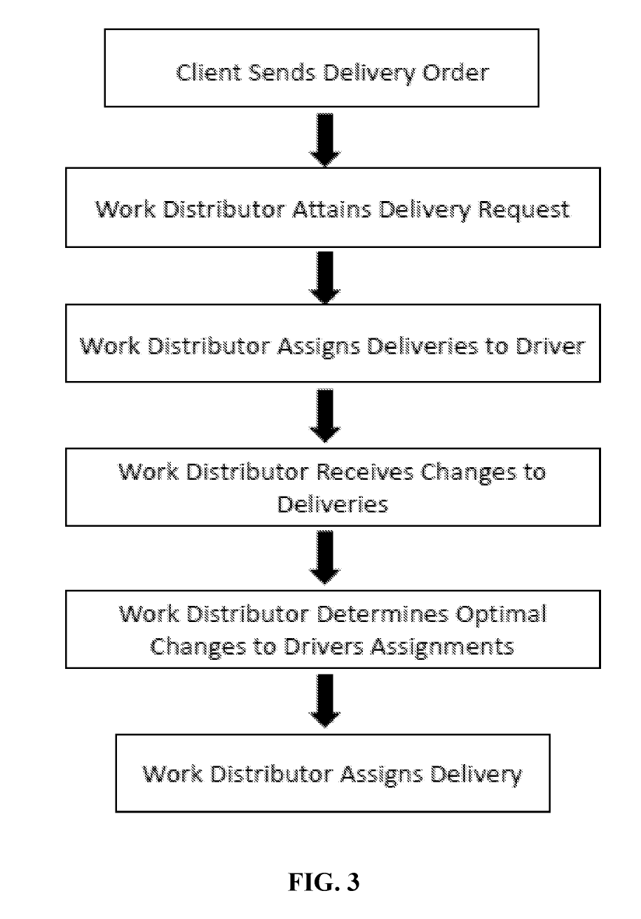

As used herein, the term “Work Distributor” refers to an instrument for dispersing, allocating, and/or assigning activities. In one embodiment, a Dispatcher utilizes a Work Distributor to assign Deliveries. In one embodiment, the Work Distributor automatically receives a request for a Delivery from a Freight Forwarder. In one embodiment, the Work Distributor attains arrival information of a Physical Concrete and Tangible Object at a Port of Discharge. In one embodiment, the Work Distributor analyzes the arrival of the Physical Concrete and Tangible Object and the Delivery address. In one embodiment, the Work Distributor automatically allocates Deliveries for efficiency. For example, the Work Distributor assigns a Delivery based on a Driver's route, allowing the Driver to deliver multiple objects efficiently. In one embodiment, the Work Distributor automatically allocates work pursuant to the rules governing Driver's working hours, e.g., assigning fewer Deliveries to Drivers with shorter working hours remaining within a period of time. In one embodiment, the Work Distributor automatically receives changes to a Delivery and searches for opportunities for optimization, e.g., reassigning a Delivery. FIG. 3 illustrates one example of how the Work Distributor assigns deliveries. In one embodiment, the Work Distributor comprises a physical, tangible display means, e.g., a GUI, e.g., a screen, e.g., a mobile device.

In one embodiment of the systems disclosed herein, the Reminder prompts the Dispatcher regarding a time dependent fee structure. For example, the systems disclosed herein automatically alert a Dispatcher of a change in Delivery time. In another example, the Reminder alerts the Dispatcher of time remaining for a mass within a port yard before surcharges take effect, e.g., mass staying in yard beyond an allotted time, or “last free day”. In one embodiment, the time dependent fee structure is based on the amount of time a Container is out of a Geofence, e.g., time outside Geofence exceeds the allotted time.

As used herein, the term “prompts the Dispatcher regarding a time dependent fee structure” refers to notifying the Dispatcher of an impending payment or a contract term that changes based on the timing of an event or events. For example, when a mass arrives at a Port of Discharge and the mass must be moved within a time period, e.g., days, weeks, etc., and the timing of movement affects cost. In one embodiment, the Delivery must be delivered within a time period in order to prevent a surcharge or fee. In one embodiment, the Dispatcher requests movement of mass to avoid penalty charges. In one embodiment, the Work Distributor alerts the Dispatcher of a potential surcharge. In one embodiment, the Dispatcher informs a Driver of a changed contract period. For example, a mass was intended to remain at a Port of Discharge 4 days, but that period of time was changed to 2 days; in response, the Dispatcher assigns the Delivery of mass to a different Driver to avoid surcharges for additional days at the Port of Discharge. In one embodiment, the systems disclosed herein automatically prompt the Dispatcher regarding a time dependent fee structure. In one embodiment, the systems disclosed herein presents the prompt, e.g., message alerts, etc., on a GUI. In one embodiment, the systems disclosed herein automatically alert the Dispatcher, e.g., via a GUI.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A Driver Management System, comprising:
a First Client;
a Delivery Order;
a Physical Concrete and Tangible Object;
a Container;
a Truck;
a Driver;
a First Destination;
a Second Destination;
a means for tracking a position of an Object; and
a Clock.

2. The Driver Management System of claim 1, wherein the Object is chosen from a Truck, Physical Concrete and Tangible Object, Container, or Driver.

3. The Driver Management System of claim 1, comprising a means for measuring Displacement of an Object.

4. The Driver Management System of claim 1, comprising a Geofence.

5. The Driver Management System of claim 1, comprising an Activity Monitor.

6. The Driver Management System of claim 1, comprising an Autologger.

7. The Driver Management System of claim 1, wherein the Autologger measures Hours of Service.

8. The Driver Management System of claim 6, wherein the Autologger documents whether a Driver is on duty or off duty.

9. The Driver Management System of claim 6, wherein the Autologger documents completion of a Delivery.

10. The Driver Management System of claim 1, comprising a Reminder.

11. The Driver Management System of claim 10, comprising a Dispatcher.

12. The Driver Management System of claim 11, wherein the Reminder prompts the Dispatcher for input based on output from the Activity monitor.

13. The Driver Management System of claim 1, comprising a Work Distributor.

14. The Driver Management System of claim 1, wherein the Reminder prompts a Dispatcher for input based on the position of an Object.

15. The Driver Management System of claim 12, wherein the Reminder prompts the Dispatcher regarding a time dependent fee structure.

16. The Drive Management System of claim 1, comprising an Invoice.
